(19) United States
(12) Patent Application Publication
(10) Pub. No.: US 2005/0095344 A1
(43) Pub. Date: May 5, 2005

(54) Method of preparation of highly functional soy protein

(75) Inventors: Ahmad Akashe, Mundelein, IL (US); Asma Ahad, Evanston, IL (US); Wen-Sherng Chen, Glenview, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/697,408

(22) Filed: Oct. 29, 2003

(51) Int. Cl. A23L 1/36

(52) U.S. Cl. 426/629

(57) ABSTRACT

Highly functional soy protein materials are provided which are prepared using a process wherein a soy protein material is hydrated in an aqueous solution at a solids level of about 5 to about 20 percent, sufficient edible base is then added to adjust the pH of the aqueous soy composition to about 9 to about 11, and the pH-adjusted composition is then mixed at a temperature of about 40 to about 80° C. for about 0.5 to about 4 hours to obtain the highly functional soy protein material. These highly functional soy protein materials have significantly improved solubilities, water binding capacities, and emulsification properties.

### BACKGROUND OF THE INVENTION

This invention relates generally to method for processing soy-derived materials to provide highly functional soy protein for use in various food products. The highly functional soy protein prepared by the present methods is ideally suited for use in dairy and non-dairy beverages, smoothies, health drinks, confectionary type products, nutritional bars, cheese products, dairy and non-dairy yogurts, meat and meat analog products, cereals, baked products, snacks, and the like.

In recent years, soy proteins have become widely used in food products, for the health benefits to be obtained from their use. There are many articles and patents which relate to processing soy materials in order to recover the protein content and which at the same time reduce the flavor compounds to make the proteins more acceptable in food products. One example is U.S. Pat. No. 4,420,425 in which protein components of soy are solubilized at a pH of 7 to 11, preferably about 8 and, after ultrafiltration through a membrane having a molecular weight cut off above 70,000, are recovered by spray drying the retained soy proteins. In variants, only a portion of the protein is solubilized at lower pH values and subjected to ultrafiltration with a membrane having a cutoff preferably above 100,000 molecular weight, the product was found to have improved color and flavor. A higher cutoff valve would be expected to result in a loss of valuable proteins. In another patent, U.S. Pat. No. 5,658,714, a soy flour slurry is pH-adjusted to the range of 7 to 10 to solubilize proteins, which are then passed through an ultrafiltration membrane and phytate and aluminum are retained, presumably as solids. Both of these patents contain extensive discussions of the efforts of others in the processing of soy materials.

In a group of related patents, Mead Johnson Company disclosed processes for solubilizing soy proteins by raising the pH of an aqueous solution of soy materials and recovering the proteins which are said to have a bland taste. The processes are principally directed to concentrating proteins rather than removing flavor compounds. In U.S. Pat. No. 3,995,071, the pH was increased to 10.1 to 14 (preferably 11 to 12) to solubilize soy proteins, after which the pH was lowered to about 6 to 10 and ultrafiltration with a membrane having a molecular weight cutoff of 10,000 to 50,000 Daltons was used to retain the proteins while discarding carbohydrates and minerals. In U.S. Pat. No. 4,072,670, emphasis was placed on removing phytates and phytic acid by solubilizing proteins at a pH of 10.6 to 14 and a temperature of 10 to 50° C. to make the phytates and phytic acid insoluble, then separating them and finally acidifying the solution to a pH of about 4 to 5 to precipitate the soy proteins. In U.S. Pat. No. 4,091,120 soy proteins were solubilized at a pH less than 10, preferably 7 to 9 and ultrafiltration was used to separate the proteins as retentate, while passing carbohydrates as permeate. In U.S. Patent Publication 2002/0114877 provides method to produce a modified oilseed material having desirable flavor and odor characteristics using alkaline extraction and a membrane-based purification process.

Efforts have also been made to provide methods whereby the functionality of vegetable protein materials, including soy protein materials, can be improved. U.S. Pat. No. 4,530,788 provided a process for improving the solubility of vegetable protein-containing solution involving adjusting the pH of an aqueous solution containing about 3.5 to about 9.5 percent vegetable protein to about 7.5 to about 12, heating the pH-adjusted solution to a temperature of about 50° C. up to the denaturing temperature of the particular protein for a time sufficient to increase the solution solubility at least about 50 percent but not sufficient to cause a drop in solubility, and then cooling the treated aqueous solution to a temperature sufficient (generally below about 60° C.) to retard further substantial change in the protein. Typically, the pH-adjusted solution is heated to about 70 to about 121° C. for a maximum period of 1 hour.

U.S. Pat. RE. 32,725 provides a method of increasing solubility of aqueous protein solutions, including aqueous soy protein solutions, by subjecting the aqueous protein solutions, under slightly alkaline conditions (e.g., pH of 7 to 8), to successive pressure and cavitation cycles (e.g., centrifugal homogenization) at temperatures below the protein denaturation temperature.

More recently, new methods have been proposed to deflavor soy proteins. These methods generally comprise (a) obtaining a soy protein composition containing soluble soy proteins, flavoring compounds, and insoluble materials; (b) solubilizing the soy proteins by adjusting the soy protein composition of (a) to a pH in the range of about 9 to about 12 and releasing the flavoring compounds; (c) passing the pH-adjusted soy protein composition of (b) adjacent an ultrafiltration membrane having a molecular weight cutoff up to about 50,000 Daltons, while maintaining the pH in the range of about 9 to about 12, under suitable ultrafiltration conditions wherein the flavor compounds pass through the membrane, thereby deflavoring the soy protein composition and retaining substantially all of the solubilized soy proteins; and (d) recovering the solubilized soy proteins retained by the ultrafiltration membrane, wherein the recovered solubilized soy proteins is the deflavored soy protein material. These new methods are more fully described in the following copending applications: U.S. patent application Ser. No. ______ (Docket 77022), filed Sep. 4, 2003 and entitled “Method of Deflavoring Soy-derived Materials”; U.S. patent application Ser. No. ______ (Docket 77013), filed Sep. 4, 2003 and entitled “Method of Deflavoring Soy-derived Materials for Use in Beverages”; U.S. patent application Ser. No. ______ (Docket 77017), filed Sep. 4, 2003 and entitled “Method of Preparation of High Quality Soy Cultured Products”; U.S. patent application Ser. No. ______ (Docket 77019), filed Sep. 4, 2003 and entitled “Method of Deflavoring Soy-derived Materials for Use in Dough-based and Baked Products”; U.S. patent application Ser. No. ______ (Docket 77023), filed Sep. 4, 2003 and entitled “Method of Deflavoring Soy-derived Materials Confectionary Type Products”; U.S. patent application Ser. No. ______ (Docket 77024), filed on the same date as the present application and entitled “Method of Preparation of High Quality Soy-containing Meat and Meat Analog Products”; and U.S. patent application Ser. No. ______ (Docket 77060), filed on the same date as the present application and entitled “Method of Preparation of High Quality Soy-containing Cheese Products.” These copending applications, which are owed by the same assignee as the present invention, are hereby incorporated by reference.

In investigating these new deflavoring methods, we have surprisingly discovered simplified methods for producing highly functional soy protein which are suited for use in various food products such as, for example, dairy and non-dairy beverages, smoothies, health drinks, confectionary type products, nutritional bars, cheese products, dairy and non-dairy yogurts, meat and meat analog products, cereals, baked products, snacks, and the like.

### SUMMARY OF THE INVENTION

The present invention provides highly functional soy protein materials. These highly functional soy protein materials have significantly improved solubilities, water binding capacities, and emulsification properties. Broadly, the highly functional soy protein material is prepared using a process wherein a soy protein material is hydrated in an aqueous solution at a solids level of about 5 to about 20 percent, sufficient edible base is then added to adjust the pH of the aqueous soy composition to about 9 to about 11, and the pH-adjusted composition is then mixed at a temperature of about 40 to about 80° C. for about 0.5 to about 4 hours to obtain the highly functional soy protein material. Preferably an edible acid is added to the alkaline suspension to adjust the pH to neutral (i.e., about 7) and the highly functional soy protein material is collected in either a concentrated or solid form. Protein solubility is increased by a factor of about 2 (or more) by the treatment of this process relative to untreated material. Moreover, the viscosity of an aqueous solution of the highly functional soy protein material is increased by a factor or about 10 (or more) by the treatment of this process relative to untreated material. Ultrafiltration, ultrafiltration/diafiltration, or other deflavoring processes are not used in the present invention to provide the highly functional soy protein material.

The functionalized soy materials prepared by the present methods are generally suited for use in dairy and non-dairy beverages, smoothies, health drinks, confectionary type products, nutritional bars, cheese products, dairy and non-dairy yogurts, meat and meat analog products, cereals, baked products, snacks, and the like. These functionalized soy materials are ideally suited for use in food products wherein potential flavor defects (i.e., those normally associated with soybeans) are masked by spices, other additives, or other components in the food products; thus, for example, these functionalized soy protein materials are ideally suited for use in meat and meat analog products, especially those containing spices and other flavoring agents.

In one embodiment, the present invention provides a highly functional soy protein material prepared by a method comprising:

(a) hydrating a suspension of a soy protein material in an aqueous composition;

(b) adjusting the pH of the aqueous composition containing the hydrated soy protein material to about 9 to about 11 by adding an edible base; and

(c) mixing the pH-adjusted aqueous composition at a temperature of about 40 to about 80° C. for about 0.5 to about 4 hours to obtain the highly functional soy protein material. Preferably, the highly functional protein material is collected by first adjusting the pH of the final aqueous composition to about neutral by addition of an edible acid and then concentrating or drying the highly functional protein material.

In another embodiment, the present invention provides a method of preparing a soy-containing food product, said method comprising

mixing a highly functional soy protein material and a food composition to form the soy-containing food product;

wherein the highly functional soy protein material is prepared by a method comprising:

(a) hydrating a suspension of a soy protein material in an aqueous composition;

(b) adjusting the pH of the aqueous composition containing the hydrated soy protein material to about 9 to about 11 by adding an edible base; and

(c) mixing the pH-adjusted aqueous composition at a temperature of about 40 to about 80° C. for about 0.5 to about 4 hours to obtain the highly functional soy protein material. Preferably, the highly functional protein material is collected by first adjusting the pH of the final aqueous composition to about neutral by addition of an edible acid and then concentrating or drying the highly functional protein material.

### DESCRIPTION OF THE PREFERRED EMBODIMENTS

Soybeans are valuable sources of oil and, in the present invention, of proteins. Soy beans contain about 40 percent proteins, which have been classified after ultracentrifugation as 2S, 7S, 11S and 15S (see also U.S. Pat. No. 4,420,425). These fractions may contain other materials as well and they have a wide molecular-weight range, generally from 3,000 to 600,000.

The process of the invention generally includes the following steps:

(1) Prepare an aqueous mixture of the soy-derived material;

(2) Add a base to raise the pH of the aqueous mixture to about 9 to about 12;

(3) Mix the pH-adjusted aqueous composition at a temperature of about 40 to about 80° C. for about 0.5 to about 4 hours to obtain the highly functional soy protein material; and, optionally,

(4) Neutralize the aqueous composition and recover the highly functional soy protein material.

All types of soy materials are considered to be potential sources of highly functional soy protein for use in food products. For example, the soy-derived or soy protein material can include soy milk, soy flour, soy concentrates, soy protein isolates, and the like as well as mixtures thereof. Thus, soy materials which contain proteins are combined into an aqueous mixture, generally a slurry of soy solids. The concentration of the soy materials in the aqueous mixture will be in the range of about 1 to about 20 percent. While in theory, any base might be used, sodium or potassium hydroxide are preferred, particularly potassium hydroxide. Other bases which may have application include calcium, magnesium and ammonium hydroxides.

The pH-adjusted aqueous composition is then mixed at a temperature of about 40 to about 80° C. for about 0.5 to about 4 hours to obtain the highly functional soy protein material. Preferably, the highly functional soy material is neutralized by adding an acid as required to reach the desired pH. After pH adjustment, the aqueous mixture of soy proteins and other materials may be used directly in food products, or it may be concentrated or dried as required for the intended use.

In a preferred embodiment, the present invention provides a method for preparing highly functional soy protein material, said method comprising: (a) preparing an aqueous composition of a soy material containing soluble soy proteins; (b) solubilizing the soy proteins by adjusting the aqueous composition of (a) to a pH in the range of about 9 to about 12; (c) removing insoluble materials that may be present from the pH-adjusted aqueous composition of (b) to obtain a treated aqueous composition; (d); mixing the treated aqueous composition at a temperature of about 40 to about 80° C. for about 0.5 to about 4 hours to obtain the highly functional soy protein material; and (e) recovering the highly functional soy protein material as a concentrate or as a dried material.

The deflavored soy protein materials prepared by the present methods are suited for use in dairy and non-dairy beverages, smoothies, health drinks, cheeses products, fermented dairy-type products such as dairy and non-dairy yogurts, meat and meat analog products, cereals, baked products, snacks, and the like. These functionalized soy materials are ideally suited for use in food products wherein potential flavor defects (i.e., those normally associated with soybeans) are masked by spices, other additives, or other components in the food products; thus, for example, these functionalized soy protein materials are ideally suited for use in meat and meat analog products, especially those containing spices and other flavoring agents. Generally the soy-containing food products of this invention are prepared by blending the desired highly functional soy protein material with a food base composition. Soy-containing food products which contain, on a dry basis, about 0.5 to about 80 percent highly functional soy protein, and more preferably about 5 to about 35 percent highly functional soy protein, can be prepared using the method of this invention. Thus, using the present invention, soy-containing food products can be prepared containing to about 2 to about 15 g, per single serving size (generally about 100 g is considered a single serving).

Unless noted otherwise, all percentages are by weight. All references cited herein are incorporated by reference.

### EXAMPLE

Soy isolate (150 g; Supro-611 from Protein Technology International (PTI); St. Louis, Mo.) was hydrated in 1350 g water (15 percent solids) for about 10 minutes with stirring. The pH of the hydrated soy isolate mixtures was adjusted to 11 with 1N NaOH. The pH-adjusted mixture was then continuously mixed at about 50° C. for about 3 hours. The resulting composition, containing the highly functional soy protein, was neutralized with 1 percent citric acid and the freeze dried.

The solubility of the highly functional soy protein was determined by suspending 2.5 g of the highly functional soy protein in deionized water (247.5 g) and then centrifuging the suspension at 27000G for 30 minutes at 25° C. The protein content of the supernate was then determined and the solubility calculated. The solubility of the highly functional soy protein was 79.7 percent as compared to a control sample's solubility of 35.1 percent. Thus, the present process provides more than a two-fold increase in solubility.

1. A highly functional soy protein material prepared by a method comprising:
(a) hydrating a suspension of a soy protein material in an aqueous composition;
(b) adjusting the pH of the aqueous composition containing the hydrated soy protein material to about 9 to about 11 by adding an edible base; and
(c) mixing the pH-adjusted aqueous composition at a temperature of about 40 to about 80° C. for about 0.5 to about 4 hours to obtain the highly functional soy protein material in a final aqueous composition.

2. The highly functional soy protein material as in claim 1, wherein the method further comprises collecting the highly functional soy protein material by adjusting the pH of the final aqueous composition to about neutral by addition of an edible acid and then concentrating or drying the highly functional protein material.

3. The highly functional soy protein material as in claim 1, wherein the soy protein material is selected from the group consisting of soy milk, soy flour, soy concentrates, soy protein isolates, and mixtures thereof.

4. The highly functional soy protein material as in claim 1, wherein the soy protein material is contained in the aqueous composition at a solids level of about 5 to about 20 percent.

5. A method of preparing a highly functional soy protein material, said method comprising:
(a) hydrating a suspension of a soy protein material in an aqueous composition;
(b) adjusting the pH of the aqueous composition containing the hydrated soy protein material to about 9 to about 11 by adding an edible base; and
(c) mixing the pH-adjusted aqueous composition at a temperature of about 40 to about 80° C. for about 0.5 to about 4 hours to obtain the highly functional soy protein material in a final aqueous composition.

6. The method as in claim 5 further comprising collecting the highly functional soy protein material by adjusting the pH of the final aqueous composition to about neutral by addition of an edible acid and then concentrating or drying the highly functional protein material.

7. The method as in claim 5, wherein the soy protein material is selected from the group consisting of soy milk, soy flour, soy concentrates, soy protein isolates, and mixtures thereof.

8. The method as in claim 5, wherein the soy protein material is contained in the aqueous composition at a solids level of about 5 to about 20 percent.

9. A soy-containing food product comprising a highly functional soy protein, said highly functional soy protein being prepared by a method comprising
(a) hydrating a suspension of a soy protein material in an aqueous composition;
(b) adjusting the pH of the aqueous composition containing the hydrated soy protein material to about 9 to about 11 by adding an edible base; and
(c) mixing the pH-adjusted aqueous composition at a temperature of about 40 to about 80° C. for about 0.5 to about 4 hours to obtain the highly functional soy protein material in a final aqueous composition.

10. The soy-containing food product as in claim 9, wherein the method further comprises collecting the highly functional soy protein material by adjusting the pH of the final aqueous composition to about neutral by addition of an edible acid and then concentrating or drying the highly functional protein material.

11. The soy-containing food product as in claim 9, wherein the soy protein material is selected from the group consisting of soy milk, soy flour, soy concentrates, soy protein isolates, and mixtures thereof.

12. The soy-containing food product as in claim 9, wherein the soy protein material is contained in the aqueous composition at a solids level of about 5 to about 20 percent.

13. The soy-containing food product as in claim 9, wherein the food product is selected from the group consisting of dairy and non-dairy beverages, smoothies, health drinks, cheeses products, fermented dairy-type products, dairy and non-dairy yogurts, meat and meat analog products, cereals, baked products, and snacks.

14. The soy-containing food product as in claim 9, wherein the food product is selected from the group consisting of meat and meat analog products.

15. The soy containing food product of claim 10, wherein the soy-containing food product contains about 2 to about 15 g soy protein per single serving size of about 100 g.

16. The soy containing food product of claim 13, wherein the soy-containing food product contains about 2 to about 15 g soy protein per single serving size of about 100 g.

17. The soy containing food product of claim 14, wherein the soy-containing food product contains about 2 to about 15 g soy protein per single serving size of about 100 g.
